(19) United States
(12) Patent Application Publication
(10) Pub. No.: US 2012/0170948 A1
(43) Pub. Date: Jul. 5, 2012

(54) Developing device including toner concentration sensor and image forming apparatus including the developing device

(75) Inventors: Ki-hwan Kwon, Hwaseong-si (KR); Tatsuhiro Otsuka, Suwon-si (KR); Soon-cheol Kweon, Seoul (KR); Dong-woo Ha, Hwaseong-si (KR)

(73) Assignee: SAMSUNG ELECTRONICS CO., LTD., Suwon-si (KR)

(21) Appl. No.: 13/067,663

(22) Filed: Jun. 17, 2011

(30) Foreign Application Priority Data
Jan. 5, 2011 (KR) 10-2011-0001088

(51) Int. Cl. G03G 15/08

(52) U.S. Cl. 399/30; 399/254

(57) ABSTRACT

A developing device using a two-component developing agent including a toner and a carrier. The developing device includes a toner concentration sensor which detects a concentration of a toner contained in the developing agent within the accommodation unit by using electrostatic capacity. The toner concentration sensor includes a frame combined with a housing that forms the accommodation unit, a measuring groove formed in the frame to be concave with respect to an inner surface of the housing so that the developing agent conveyed by the agitator is flowed into the measuring groove, and a pair of opposite electrodes disposed on the measuring groove.

### CROSS-REFERENCE TO RELATED APPLICATIONS

This application claims the priority benefit of Korean Patent Application No. 10-2011-0001088, filed on Jan. 5, 2011, in the Korean Intellectual Property Office, the disclosure of which is incorporated herein in its entirety by reference.

### BACKGROUND

1. Field

Embodiments relate to a developing device using a two-component developing agent including a toner and a magnetic carrier and an image forming apparatus including the developing device.

2. Description of the Related Art

Electrophotographic image forming apparatuses form an electrostatic latent image on the surface of a photoconductor by scanning light modulated to correspond to image information onto the photoconductor, supply a toner to the electrostatic latent image to develop the electrostatic latent image as a visible toner image, and then transfer and fuse the developed toner image to and on a printing medium, thereby printing a desired image on a recording medium.

Image forming methods of electrophotographic image forming apparatuses may include a one-component developing method using a one-component developing agent including a toner and a two-component developing method using a two-component developing agent in which a toner and a carrier are mixed, whereby only the toner is used to develop an electrostatic latent image formed on the surface of a photoconductor.

### SUMMARY

An aspect of embodiments provide a developing device that may detect a concentration of a toner contained in the developing device with reliability and an image forming apparatus including the developing device.

According to an aspect of one or more embodiments, there is provided a developing device including: a developing roller; an accommodation unit to accommodate a two-component developing agent including a toner and a carrier; an agitator to supply the developing agent to the developing roller; and a toner concentration sensor which detects a concentration of the toner contained in the developing agent within the accommodation unit by using electrostatic capacity, wherein the toner concentration sensor includes: a frame which is combined with a housing that forms the accommodation unit; a measuring groove which is formed in the frame to be concave with respect to an inner surface of the housing so that the developing agent conveyed by the agitator flows into the measuring groove; and a pair of opposite electrodes disposed on the measuring groove.

The agitator may include a rotation shaft and spiral agitating wings which are disposed on the rotation shaft and which may convey the developing agent in an axial direction of the agitator, and the pair of opposite electrodes may be separated from each other in the axial direction of the agitator. The measuring groove may be curved so that a cross-section of the measuring groove that crosses the axial direction of the agitator is concave. A first inclined face and a second inclined face may be respectively formed at an upstream side and a downstream side of the measuring groove based on a rotation direction of the agitator.

The agitator may include a rotation shaft and spiral agitating wings which are disposed on the rotation shaft to convey the developing agent in an axial direction of the agitator, and the pair of opposite electrodes may be separated from each other in the axial direction of the agitator. A first inclined face and a second inclined face may be respectively formed at an upstream side and a downstream side of the measuring groove based on a rotation direction of the agitator. An inlet downwardly-inclined face and a discharge upwardly-inclined face may be respectively formed at an upstream side and a downstream side of the measuring groove in a direction in which the developing agent is conveyed by the agitator.

The developing device may further include a cleaning blade which is disposed on the rotation shaft of the agitator and which sweeps the developing agent in the measuring groove as the agitator is rotated. The developing device may further include a magnetic member which is disposed on the rotation shaft of the agitator and which removes the developing agent from the measuring groove due to a magnetic force as the agitator is rotated. The magnetic member may be a first cleaning member. The developing device may further include a second cleaning member which is disposed at the upstream side of the measuring groove based on the rotation direction of the agitator, which collides with the developing agent attached to the magnetic member and which removes the developing agent from the magnetic member.

The measuring groove may be positioned in a vertical downward direction of the agitator. A width of the measuring groove in a direction that crosses the axial direction of the agitator may be less than a diameter of each of the agitating wings.

According to another aspect of one or more embodiments, there is provided a developing device including: an accommodation unit accommodating a two-component developing agent including a toner and a carrier; an agitator disposed in the accommodation unit and conveying the developing agent in an axial direction of the agitator as the agitator is rotated; and a toner concentration sensor for detecting a concentration of the toner contained in the developing agent in the accommodation unit by using electrostatic capacity, wherein the toner concentration sensor includes: a measuring groove formed in a vertical downward direction of the agitator to be concave with respect to an inner surface of the housing that forms the accommodation unit; a pair of opposite electrodes which is disposed on the measuring groove to face each other in one of the axial direction of the agitator and a direction that crosses the axial direction; and a first cleaning member which removes the developing agent from the measuring groove at least once when the agitator is rotated once.

The first cleaning member may include a magnetic member which is disposed on the rotation shaft of the agitator and which removes the developing agent from the measuring groove due to a magnetic force as the agitator is rotated. The developing device may further include a second cleaning member which is disposed at the upstream side of the measuring groove based on the rotation direction of the agitator, which collides with the developing agent attached to the magnetic member, and which removes the developing agent from the magnetic member. The pair of opposite electrodes may face each other in the direction that crosses the axial direction of the agitator, and an inlet downwardly-inclined face and a discharge upwardly-inclined face may be respectively formed at an upstream side and a downstream side of the measuring groove in the axial direction of the agitator.

According to another aspect of one or more embodiments, there is provided an image forming apparatus including: a photoconductor on which an electrostatic latent image is formed; and the above-described developing device supplying a toner to the electrostatic latent image to develop the electrostatic latent image.

### BRIEF DESCRIPTION OF THE DRAWINGS

The above and other aspects of embodiments will become more apparent by describing in detail embodiments thereof with reference to the attached drawings in which:

FIG. 1 illustrates a structure of an image forming apparatus according to an embodiment;

FIG. 2 illustrates a developing operation of the image forming apparatus illustrated in FIG. 1;

FIG. 3 is an exploded perspective view of a toner concentration sensor according to an embodiment;

FIG. 4 is a circuit diagram for measuring a toner concentration, according to an embodiment;

FIG. 5 is a graph showing the relationship between an output voltage and a toner concentration of a capacity type toner concentration sensor;

FIG. 6 illustrates a case where a measuring region of a toner concentration sensor is formed between agitating wings;

FIG. 7 illustrates a case where agitating wings are positioned within the measuring region of the toner concentration sensor;

FIG. 8 illustrates a case where space is formed in the measuring region of the toner concentration sensor;

FIG. 9 illustrates a case where a developing agent in a measuring groove is removed using a blade;

FIG. 10 illustrates a case where a developing agent in a measuring groove is removed using a magnetic member;

FIGS. 11 and 12 illustrate modified examples of opposite electrodes;

FIG. 13 is a perspective view including a measuring groove that is long in an axial direction of an agitator;

FIG. 14 is a cross-sectional view taken along line X-X′ of FIG. 13; and

FIG. 15 is a cross-sectional view taken along line Y-Y′ of FIG. 13.

### DETAILED DESCRIPTION

Embodiments will now be described more fully with reference to the accompanying drawings, in which embodiments are shown.

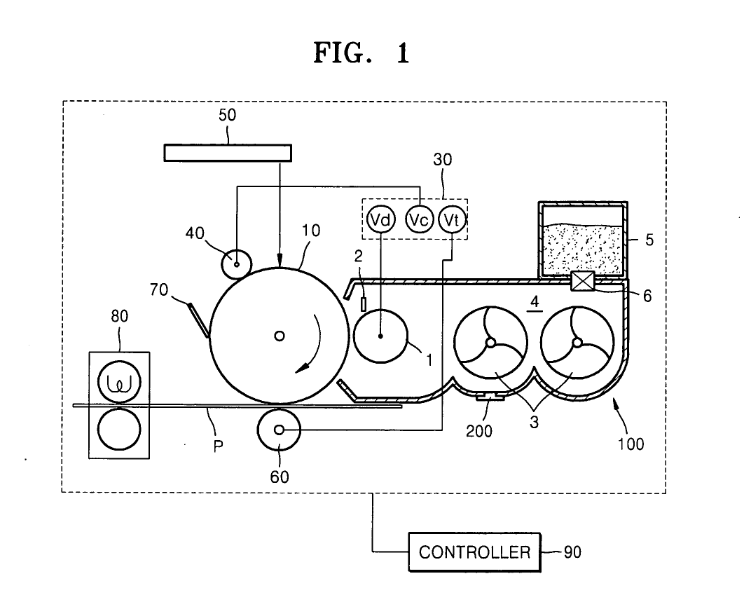

FIG. 1 schematically illustrates a structure of an image forming apparatus according to an embodiment. The image forming apparatus according to the current embodiment is a monochromatic image forming apparatus using a two-component developing agent including a toner and a magnetic carrier as a developing agent. A color of the toner may be black, for example.

A photoconductive drum 10 is an example of a photoconductive body on which an electrostatic latent image is formed and in which a photoconductive layer having photoconductivity is formed on an outer circumferential portion of a cylindrical metal pipe. A photoconductive belt in which a photoconductive layer is formed on an outer surface of a circulating belt, instead of the photoconductive drum 10 may be used.

A charging roller 40 is an example of a charger for charging the surface of the photoconductive drum 10 to a uniform charging electric potential. A charging bias voltage Vc is applied to the charging roller 40. A corona charger using corona discharge, instead of the charging roller 40 may be used.

An exposing unit 50 forms an electrostatic latent image by scanning light corresponding to image information onto the surface of the charged photoconductive drum 10. A laser scanning unit (LSU) that deflects light emitted from a laser diode by using a polygon mirror in a main scanning direction to be scanned onto the photoconductive drum 10, for example, may be used as the exposing unit 50.

A developing device 100 forms a visible toner image on the surface of the photoconductive drum 10 by supplying a toner contained in the developing device 100 to the electrostatic latent image formed on the photoconductive drum 10. A developing roller 1 faces the photoconductive drum 10. The developing roller 1 may be separated from the photoconductive drum 10 by a developing gap. The developing gap may be set to about several tens through several hundreds microns.

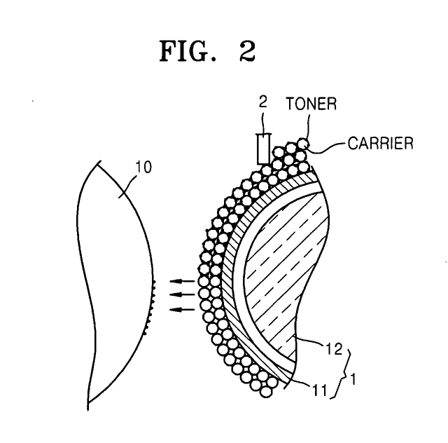

FIG. 2 illustrates a developing operation of the image forming apparatus illustrated in FIG. 1. Referring to FIG. 2, the developing roller 1 may include a rotating sleeve 11 and a magnet 12 positioned within the sleeve 11. Due to a magnetic force of the magnet 12, a magnetic carrier is attached to an outer circumferential portion of the developing roller 1, and the toner is attached to the magnetic carrier due to an electrostatic force. Then, a developing agent layer including the magnetic carrier and the toner is formed on the outer circumference portion of the developing roller 1, as illustrated in FIG. 2. A regulator 2 regulates the thickness of the developing agent layer to a uniform thickness. A distance between the regulator 2 and the developing roller 1 may be about 0.3 to 1.5 mm, for example. A developing agent is accommodated in an accommodation unit 4. An agitator 3 supplies the developing agent to the developing roller 1. In addition, the agitator 3 agitates the toner and the magnetic carrier to charge the toner by friction. The toner may be negatively-charged or positively-charged. FIG. 1 illustrates two agitators 3. However, embodiments are not limited thereto. If necessary, one agitator 3 or three or more agitators 3 may be positioned within the accommodation unit 4.

The toner to be supplied to the accommodation unit 4 is accommodated in a toner supply portion 5. Supply of the toner from the toner supply portion 5 to the accommodation unit 4 may be controlled by a toner supply unit 6. The toner supply unit 6 may be a shutter disposed between the toner supply portion 5 and the accommodation unit 4, for example. In addition, the toner supply unit 6 may be a carrying unit such as an auger for carrying the toner to the accommodation unit 4 from the toner supply portion 5, for example. The toner supply portion 5 may be formed with the developing device 100 as a one body or may be coupled to the developing device 100.

A transfer bias voltage Vt is applied to a transfer roller 60. The toner image formed on the surface of the photoconductive drum 10 is transferred onto a recording medium P due to a transfer electric field formed between the photoconductive drum 10 and the transfer roller 60 in response to the transfer bias voltage Vt. A corona transfer unit using corona discharge, instead of the transfer roller 60 may be used.

The toner image transferred onto the recording medium P is attached to the recording medium P due to an electrostatic force. A fusing unit 80 fuses the toner image on the recording medium P by applying heat and pressure to the toner image.

A power supply unit 30 supplies a developing bias voltage Vd, a charging bias voltage Vc, and a transfer bias voltage Vt to the developing roller 1, the charging roller 40, and the transfer roller 60, respectively.

When the charging bias voltage Vc is applied to the charging roller 40, the surface of the photoconductive drum 10 is charged to a uniform electric potential. The exposing unit 50 forms an electrostatic latent image by scanning light corresponding to image information onto the surface of the photoconductive drum 10. When the developing bias voltage Vd is applied to the developing roller 1 and a developing electric field is formed between the developing roller 1 and the photoconductive drum 10, the toner is moved from the developing agent layer formed on the surface of the developing roller 1 to the surface of the photoconductive drum 10 and thereby is used to develop the electrostatic latent image. The toner image is formed on the surface of the photoconductive drum 10. The recording medium P is supplied by a paper feeding unit (not shown) to a region in which the photoconductive drum 10 and the transfer roller 60 face each other. Due to the transfer electric field formed in response to the transfer bias voltage Vt, the toner image is moved from the surface of the photoconductive drum 10 to the recording medium P and then is attached to the recording medium P. The recording medium P passes the fusing unit 80 due to heat and pressure, and the toner image is fused on the recording medium P and thereby, an operation of printing an image is completed. A cleaning blade 70 contacts the surface of the photoconductive drum 10 to remove the toner that remains on the surface of the photoconductive drum 10 after the transfer operation is performed.

Referring back to FIG. 1, a toner concentration sensor 200 that measures a concentration of the toner contained in the developing agent accommodated in the accommodation unit 4, is positioned within the developing device 100. In order to realize a uniform image concentration, the concentration of the toner in the accommodation unit 4 needs to be maintained at a constant level. The concentration of the toner is the ratio of the amount of the toner to the amount of the developing agent contained in the accommodation unit 4. In order to maintain the concentration of the toner at a desired level, a controller 90 may control the toner supply unit 6 based on a detected value of a toner concentration sensor 200 to adjust the amount of the toner to be supplied to the accommodation unit 4 from the toner supply portion 5. In detail, when the concentration of the toner is low, the controller 90 may control the toner supply unit 6 to supply the toner to the accommodation unit 4 from the toner supply portion 5.

A capacity type sensor is used as the toner concentration sensor 200. The capacity type sensor is a sensor using the electrostatic capacity of a capacitor depending on a distance between two facing plates and permittivity of material inserted between the two plates at the distance.

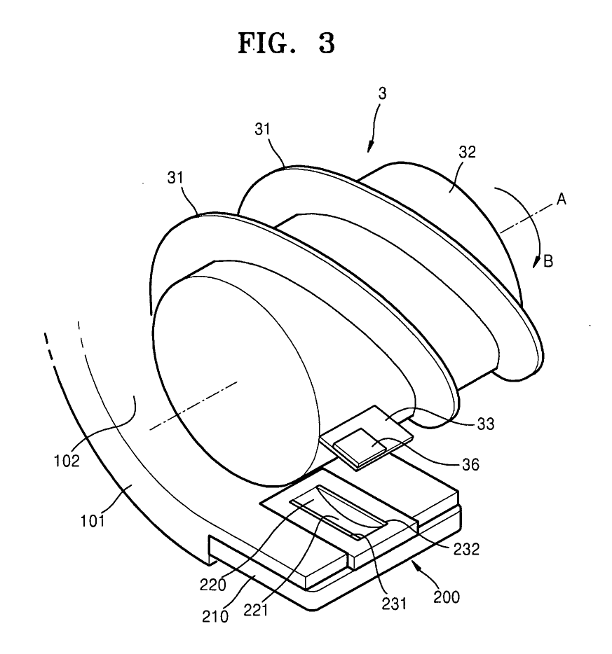

FIG. 3 is an exploded perspective view of a toner concentration sensor according to an embodiment. Referring to FIG. 3, an auger including spiral agitating wings 31 and a rotation shaft 32 is used as the agitator 3. The toner concentration sensor 200 is disposed under the agitator 3. The toner concentration sensor 200 includes an electrical insulating frame 210 having a measuring groove 220 and conductive opposite electrodes 231 and 232 disposed in the measuring groove 220. The conductive opposite electrodes 231 and 232 are separated from each other in an axial direction A of the agitator 3. The measuring groove 220 is concave with respect to an inner surface 102 of a housing 101 that forms the accommodation unit 4. In detail, a bottom surface 221 of the measuring groove 220 is formed in a lower position than the inner surface 102 of the housing 101. If the agitator 3 is rotated in a direction of arrow B, the developing agent is conveyed to the axial direction A of the agitator 3 and then is flowed into the measuring groove 220. The magnetic carrier and the toner have different permittivities. Thus, the electrostatic capacity of the toner concentration sensor 200 to be modeled as a capacitor varies according to the amount of the magnetic carrier and the amount of the toner contained between the opposite electrodes 231 and 232. The concentration of the toner contained in the developing agent may be measured by using the electrostatic capacity of the toner concentration sensor 200.

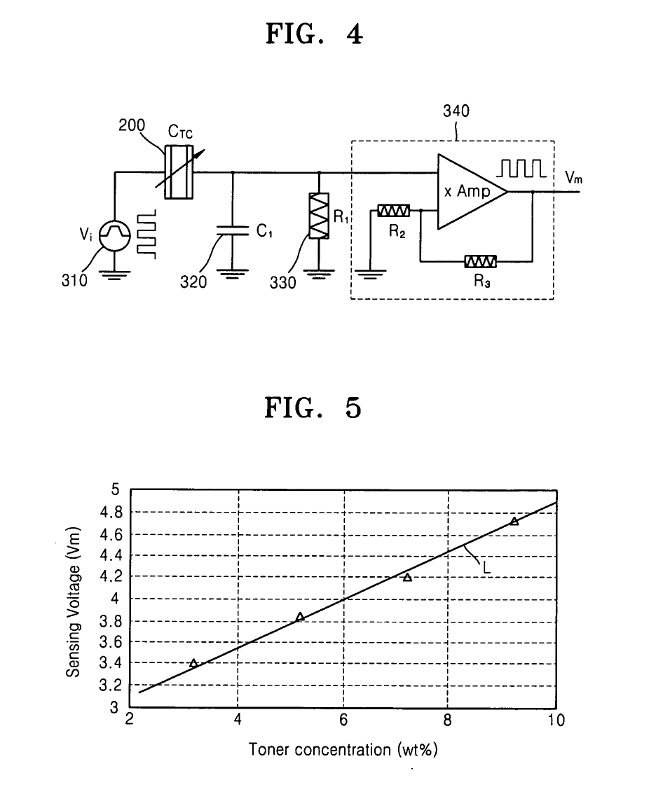

FIG. 4 illustrates an example of a circuit for measuring a toner concentration by using the toner concentration sensor 200. Referring to FIG. 1, the circuit for measuring a toner concentration includes a measuring power supply 310 that applies an alternating current (AC) voltage, a capacitor 320 for adjusting sensitivity, and a measuring resistor 330. The toner concentration sensor 200 is indicated by a capacitor having an electrostatic capacity of C_{TC}. An amplifier 340 amplifies voltage applied to the measuring resistor 330. If voltage applied to the measuring power supply 310 is Vᵢ the electrostatic capacity of the toner concentration sensor 200 is C_{TC}, the electrostatic capacity of the capacitor 320 for adjusting sensitivity is C₁, a resistance of the measuring resistor 330 is R₁ and a gain of the amplifier 340 is G_{AMP}, an output voltage Vₘ may be obtained using the following Equation:

$${V}_{m} = \frac{ω {C}_{TC} {R}_{1}}{\sqrt{1 + {( ω ( {C}_{TC} + {C}_{1} ) {R}_{1} )}^{2}}} {G}_{AMP} {V}_{i} .$$

Since the toner and the magnetic carrier have different permittivites, the electrostatic capacity C_{TC} of the toner concentration sensor 200 varies according to the amount of the toner and the amount of the magnetic carrier contained in the measuring groove 220. Thus, the concentration of the toner may be measured from the output voltage Vₘ. A circuit board (not shown) including the above-described measuring circuit is arranged on the frame 210 of the toner concentration sensor 200. Thus, the output voltage Vₘ may be transmitted to the controller 90 of the image forming apparatus. Of course, the above-described measuring circuit may be disposed on a printed circuit board (PCB) that forms the controller 90.

FIG. 5 illustrates an experimental example in which the output voltage Vₘ is measured according to toner concentrations. An experimental condition thereof is as below.

Sizes of opposite electrodes 231 and 232: 10 mm×5 mm

Distance between opposite electrodes 231 and 232: 2 mm

Voltage Vᵢ of measuring power supply 310: 50 V, 10 kHz

Gain of amplifier 340: G_{AMP}=30

Electrostatic capacity C₁ of capacitor 320 for adjusting sensitivity: 100 pF

Resistance R1 of measuring resistor 330: 5 MΩ

In FIG. 5, the output voltage Vₘ varies nearly linearly according to the concentration of the toner. By increasing the electrostatic capacity C₁ of the capacitor 320 for adjusting sensitivity, sensitivity of the output voltage Vₘ may be increased. In addition, as the distance between the opposite electrodes 231 and 232 is reduced, sensitivity of the output voltage Vₘ with respect to variations in the toner concentration may be increased. In detail, a gradient of a straight line L in FIG. 5 may become more steep.

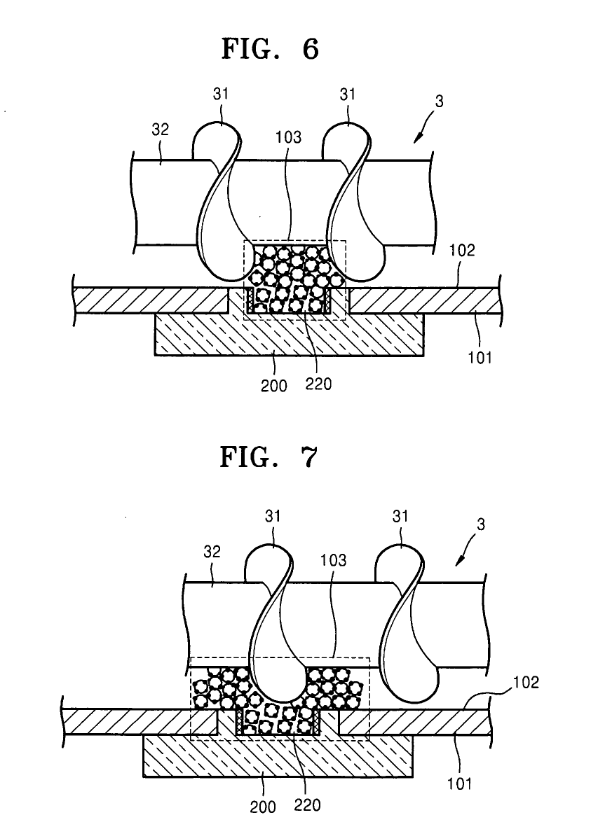

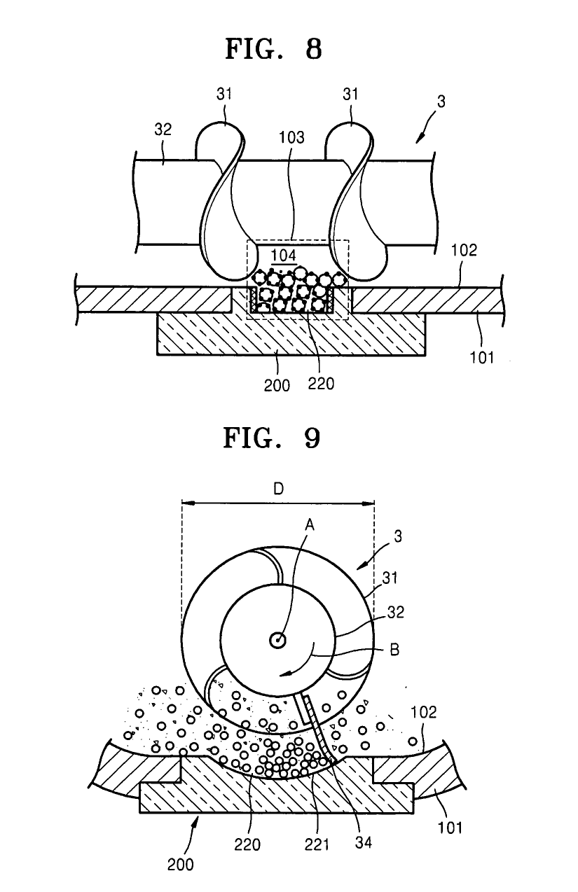

In the toner concentration sensor 200 having the above structure, stability of the output voltage Vₘ is high. In other words, the output voltage Vₘ of the toner concentration sensor 200 is affected by the amount of the toner and the amount of the magnetic carrier contained in the measuring groove 220 and is not affected by the toner and the magnetic carrier contained in a region between the inner surface 102 of the housing 101 and the agitator 3. For example, when a measuring region 103 of the toner concentration sensor 200 is formed between two agitating wings 31, as illustrated in FIG. 6, and when the agitating wings 31 are positioned within the measuring region 103 of the toner concentration sensor 200, as illustrated in FIG. 7, and when the amount of the developing agent in the accommodation unit 4 is insufficient or the state of the developing agent conveyed by the agitator 3 is not uniform in the axial direction A of the agitator 3 and thus there is an empty space 104 in the measuring region 103, as illustrated in FIG. 8, the output voltage Vₘ is affected by the amount of the toner and the amount of the magnetic carrier in the measuring groove 200 so that the concentration of the toner may be precisely detected.

A magnetic sensor according to the related art may be used as the toner concentration sensor 200. The toner and the magnetic carrier are mixed in the accommodation unit 4. When the amount of the magnetic carrier is measured by using the magnetic sensor, the concentration of the toner may be indirectly checked. In detail, when the amount of the toner contained in a sensing region of the magnetic sensor is large, the amount of the magnetic carrier is relatively small and thus, an output of the magnetic sensor is decreased. On the contrary;when the amount of the toner contained in the sensing region of the magnetic sensor is small, the amount of the magnetic carrier is relatively large and thus, an output of the magnetic sensor is increased. However, an error may occur in values measured by the magnetic sensor according to the state of the agitator 3 that agitates the developing agent in the accommodation unit 4. For example, when the measuring region 103 is formed between the agitating wings 31, as illustrated in FIG. 6, a large amount of the magnetic carrier is collected in the measuring region 103 and thus, the toner concentration measured by a toner concentration sensor according to the related art may be relatively lower than an actual toner concentration. When the agitating wings 31 are positioned within the measuring region 103, as illustrated in FIG. 7, a small amount of the magnetic carrier is collected in the measuring region 103 and thus, the toner concentration measured by a toner concentration sensor according to the related art may be relatively higher than an actual toner concentration. In addition, for example, when the amount of the developing agent in the accommodation unit 4 is insufficient or the state of the developing agent conveyed by the agitator 3 is not uniform in the axial direction A of the agitator 3 and thus there is an empty space 104 in the measuring region 103, as illustrated in FIG. 8, the toner concentration measured by a toner concentration sensor according to the related art may be relatively higher than an actual toner concentration. In addition, even when the performance of the magnetic carrier is partially lowered due to a change with time elapse, an error may occur in measuring the concentration of the toner in the accommodation unit 4.

However, since, in the capacity type toner concentration sensor 200, the output voltage Vₘ is affected by the amount of the toner and the amount of the carrier in the measuring groove 220, as described above, the concentration of the toner may be precisely detected without being affected by factors such as non-uniform performance of conveying the developing agent by using the agitator 3, the position of the toner concentration sensor 200 in the axial direction A of the agitator 3, and the arrangement state of the measuring region 103 and the agitating wings 31.

According to the current embodiment, due to the developing agent conveyed in the axial direction A of the agitator 3 as the agitator 3 is rotated, the developing agent in the measuring groove 220 is swept and is removed, and a new developing agent is flowed into the measuring groove 220. Thus, the developing agent is not retained in the measuring groove 220 and is continuously replaced with a new developing agent so that an output voltage of the toner concentration sensor 200 may represent the concentration of the toner in the accommodation unit 4.

The developing device 100 according to the current embodiment may include a first cleaning member for removing the developing agent from the measuring groove 220 as the agitator 3 is rotated. The first cleaning member removes the developing agent from the measuring groove 220 at least once when the agitator 3 is rotated once. FIG. 9 illustrates a case where a developing agent in a measuring groove is removed using a blade. Referring to FIG. 9, the first cleaning member may include a cleaning blade 34 disposed on the rotation shaft 32 of the agitator 3. The width of the cleaning blade 34 in the axial direction A of the agitator 3 corresponds to the width of the measuring groove 220 in the axial direction A of the agitator 3. The width of the cleaning blade 34 may be less than that of the measuring groove 220 so that the cleaning blade 34 may smoothly enter the measuring groove 220. As the agitator 3 is rotated, the cleaning blade 34 sweeps the developing agent in the measuring groove 220 and removes the developing agent therefrom. Thus, a new developing agent to be conveyed by the agitator 3 in the axial direction A of the agitator 3 is flowed into the measuring groove 220. Thus, the developing agent in the measuring groove 220 is replaced with a new developing agent according to a rotation period of the agitator 3 so that the concentration of the toner in the accommodation unit 4 may be stably measured. The cleaning blade 34 may be a flexible film or a rubber. A brush (not shown), instead of the cleaning blade 34, may also be used as the first cleaning member. FIG. 9 illustrates only one cleaning blade 34. However, embodiments not limited thereto. If necessary, a plurality of cleaning blades 34 may be disposed on the rotation shaft 32 of the agitator 3.

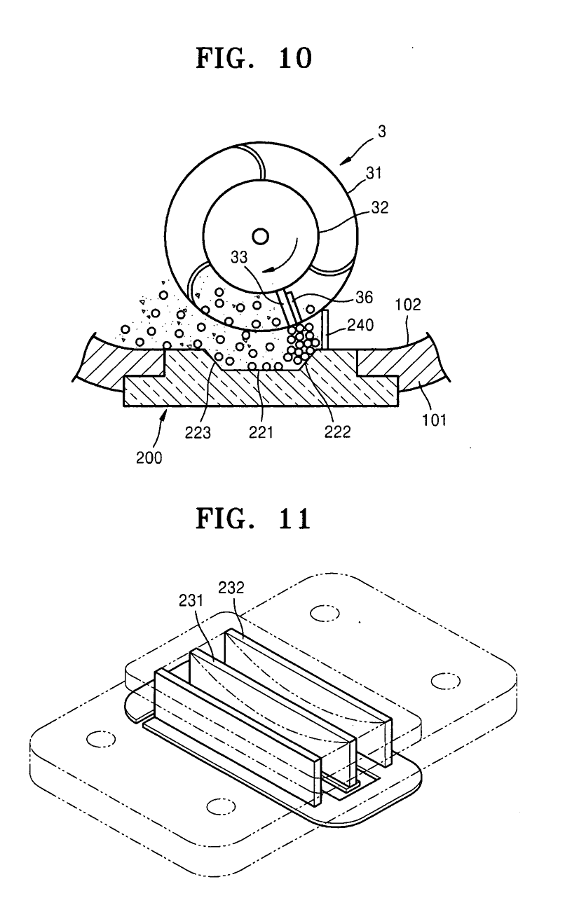

FIG. 10 illustrates a case where the developing agent in the measuring groove 220 is removed using a magnetic member. Referring to FIGS. 3 and 10, the first cleaning member may include a magnetic member 36 disposed on the rotation shaft 32 of the agitator 3. For example, the magnetic member 36 may be disposed on a rib 33 that protrudes from the rotation shaft 32 of the agitator 3. The position of the magnetic member 36 corresponds to the position of the measuring groove 220 of the toner concentration sensor 200. The width of the magnetic member 36 in the axial direction A of the agitator 3 corresponds to the width of the measuring groove 220 in the axial direction A of the agitator 3. As the agitator 3 is rotated, the magnetic member 36 faces the measuring groove 220. The magnetic carrier in the measuring groove 220 is attached to the magnetic member 36 due to a magnetic force, and the toner is attached to the magnetic carrier and is discharged from the measuring groove 220. Thus, a new developing agent to be conveyed by the agitator 3 in the axial direction A of the agitator 3 is flowed into the measuring groove 220. Thus, the developing agent in the measuring groove 220 is replaced with a new developing agent according to a rotation period of the agitator 3 so that the concentration of the toner in the accommodation unit 4 may be stably measured. FIG. 10 illustrates only one magnetic member 36. However, embodiments are not limited thereto. If necessary, a plurality of magnetic members 36 may be disposed on the rotation shaft 32 of the agitator 3.

In addition, as illustrated in FIG. 10, in order to improve the performance of the magnetic member 36 for removing the developing agent from the measuring groove 220, a second cleaning member 240 for removing the developing agent attached to the magnetic member 36 before the magnetic member 36 reaches the measuring groove 220, may be provided. The second cleaning member 240 may be disposed on a frame 210 of the toner concentration sensor 200. The second cleaning member 240 is positioned at an upstream side of the measuring groove 220 based on a rotation direction B of the agitator 3. The magnetic carrier and the toner attached to the magnetic member 36 collide with the second cleaning member 240 and escape from the magnetic member 36 before they reach the measuring groove 220. The second cleaning member 240 protrudes from the frame 210 and may be formed with the frame 210 as a one body. In addition, the second cleaning member 240 may be a flexible blade formed as a rubber or plastic film and may be combined with the frame 210. Although not shown, the second cleaning member 240 may be disposed on the housing 101.

In order to easily remove the developing agent from the measuring groove 220 by using the first cleaning member, the bottom surface 221 of the groove 220 may be curved in a direction that crosses the axial direction A of the agitator 3, as illustrated in FIG. 9. In addition, as illustrated in FIG. 10, the bottom surface 221 may be planar, and a first inclined face 222, and a second inclined face 223, which are respectively inclined at the upstream side and the downstream side of the measuring groove 220 based on the rotation direction B of the agitator 3, may be formed. The first and second inclined faces 222 and 223 may be planar or curved.

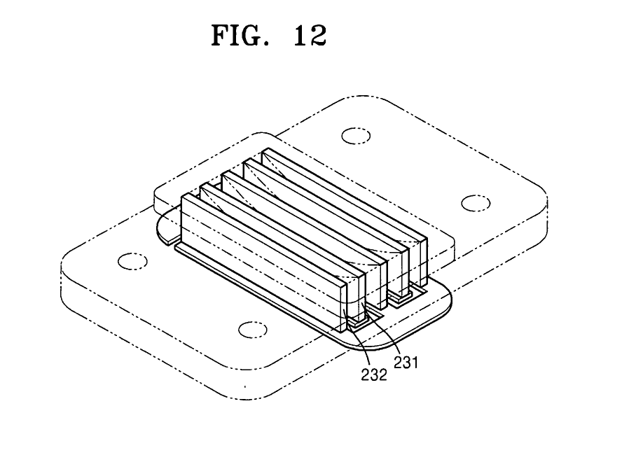

FIGS. 11 and 12 illustrate modified examples of opposite electrodes. The shape of the opposite electrodes 231 and 232 is not limited to the examples illustrated in FIGS. 3, 9, and 10. For example, as illustrated in FIG. 11, an opposite electrode 231 may be disposed between U-shaped opposite electrodes 232. In addition, as illustrated in FIG. 12, a U-shaped opposite electrode 231 may be disposed between W-shaped opposite electrodes 232. Besides, opposite electrodes 231 and 232 having various shapes may be used.

In FIGS. 3, 9, and 10, the measuring groove 220 is long in the direction that crosses the axial direction A of the agitator 3. The measuring groove 220 is positioned in a vertical downward direction of the agitator 3 and is positioned in a rotation region of the agitator 3, i.e., within the range of a diameter D of each of the agitating wings 31 of the agitator 3. This arrangement is appropriate to smooth supplying of the developing agent to the measuring groove 220 and easy removing of the developing agent from the measuring groove 220. The arrangement is also appropriate to precise measuring of the toner concentration even when a small amount of the developing agent remains in the accommodation unit 4.

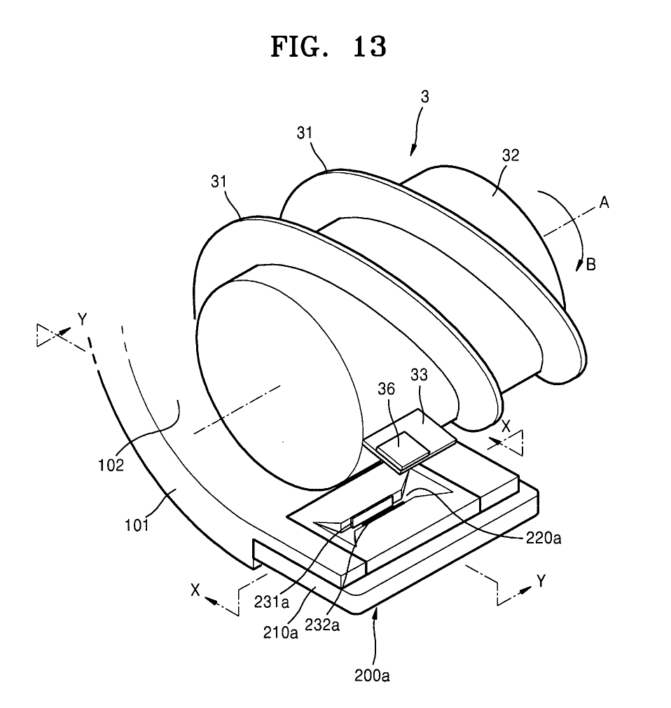

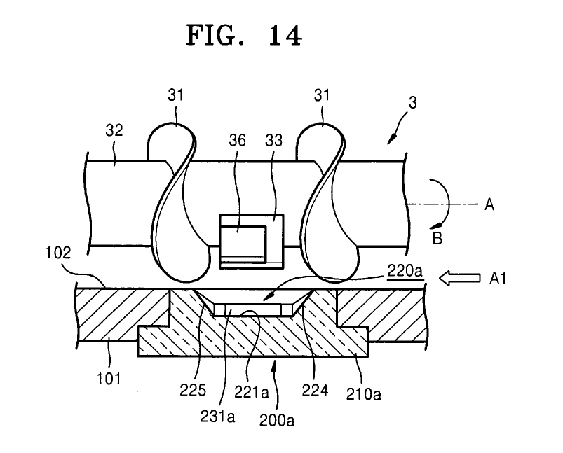

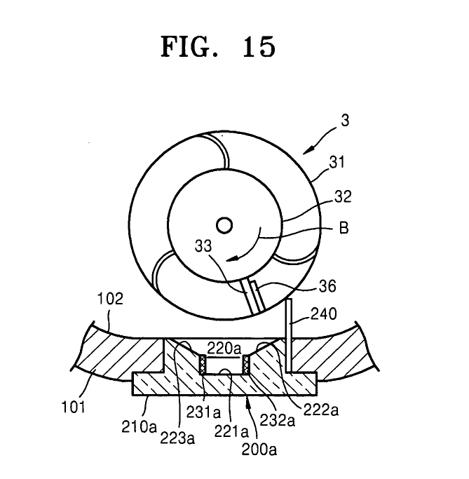

In FIGS. 3, 9, and 10, the measuring groove 220 is long in the direction that crosses the axial direction A of the agitator 3. However, embodiments are not limited thereto. FIG. 13 is a perspective view including a measuring groove 220a that is long in an axial direction of the agitator 3. Referring to FIG. 13, a toner concentration sensor 200a includes the measuring groove 220a formed in the axial direction A of the agitator 3. FIGS. 14 and 15 are cross-sectional views taken along lines X-X′ and Y-Y′ of FIG. 13, respectively.

Referring to FIGS. 13 through 15, the toner concentration sensor 200a includes an electrical insulating frame 210a having the measuring groove 220a formed long in the axial direction A of the agitator 3 and conductive opposite electrodes 231a and 232a disposed on the measuring groove 220a. The opposite electrodes 231a and 232a are separated from each other in the direction that crosses the axial direction A of the agitator 3. The measuring groove 220a is concave with respect to the inner surface 102 of the housing 101 that forms the accommodation unit 4. In detail, a bottom surface 221a of the measuring groove 220a is formed in a lower position than the inner surface 102 of the housing 101.

Referring to FIG. 14, as the agitator 3 is rotated in a direction B, a developing agent is conveyed in a direction A1 and is flowed into the measuring groove 220a. In this regard, an inlet inclined face 224 in a downward direction toward the bottom surface 221a may be formed at the upstream side of a direction A1 in which the developing agent is conveyed to the measuring groove 220a so that the developing agent may be easily flowed into the measuring groove 220a. In addition, as the developing agent is conveyed in the direction A1, a discharge inclined face 225 in an upward direction from the bottom surface 221a may be formed at the downstream side of the direction A1 in which the developing agent is conveyed to the measuring groove 220a so that the developing agent in the measuring groove 220a may be easily discharged from the measuring groove 220a. In the above structure, the developing agent is smoothly flowed into the measuring groove 220a and is discharged due to the conveying operation of the agitator 3. Thus, the flow of the developing agent is continuously maintained in the measuring groove 220a so that the toner concentration in the accommodation unit 4 may be precisely measured.

Referring to FIGS. 14 and 15, in order to effectively remove the developing agent from the measuring groove 220a, a magnetic member 36 for removing the developing agent from the measuring groove 220a due to a magnetic force may be disposed on a rib 33 that protrudes from the rotation shaft 32 of the agitator 3. In order to easily remove the developing agent from the measuring groove 220a by using the magnetic member 36, as illustrated in FIG. 15, the bottom surface 221a may be planar, and a first inclined face 222a and a second inclined face 223a, which are respectively inclined at the upstream side and the downstream side of the measuring groove 220a based on the rotation direction B of the agitator 3, may be formed. The first and second inclined faces 222a and 223a may be planar or curved. In order to improve the performance of removing the developing agent from the measuring groove 220a by using the magnetic member 36, a second cleaning member 240 for removing the developing agent attached to the magnetic member 36 before the magnetic member 36 reaches the measuring groove 220a, may be disposed on a frame 210a. The second cleaning member 240 is positioned at an upstream side of the measuring groove 220 based on the rotation direction B of the agitator 3. The magnetic carrier and the toner attached to the magnetic member 36 collide with the second cleaning member 240 and escape from the magnetic member 36 before they reach the measuring groove 220a. Thus, the developing agent in the measuring groove 220a may be attached to the magnetic member 36 and may be stably removed from the measuring groove 220a.

Although the monochromatic image forming apparatus has been described as above, the image forming apparatus according to one or more embodiments may be applied to a single path type color image forming apparatus having a tandem structure and a multi-path type color image forming apparatus in which a developing operation is performed on a one photoconductor several times and a sequential transfer operation onto an intermediate transfer body is performed.

While embodiments have been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A developing device comprising:
a developing roller;
an accommodation unit to accommodate a two-component developing agent comprising a toner and a carrier;
an agitator to supply the developing agent to the developing roller; and
a toner concentration sensor which detects a concentration of the toner contained in the developing agent within the accommodation unit by using electrostatic capacity,
wherein the toner concentration sensor comprises:
a frame which is combined with a housing that forms the accommodation unit;
a measuring groove which is formed in the frame to be concave with respect to an inner surface of the housing so that the developing agent conveyed by the agitator flows into the measuring groove; and
a pair of opposite electrodes disposed on the measuring groove.

2. The developing device of claim 1, wherein the agitator comprises a rotation shaft and spiral agitating wings which are disposed on the rotation shaft and which convey the developing agent in an axial direction of the agitator, and the pair of opposite electrodes are separated from each other in the axial direction of the agitator.

3. The developing device of claim 2, wherein the measuring groove is curved so that a cross-section of the measuring groove that crosses the axial direction of the agitator is concave.

4. The developing device of claim 2, wherein a first inclined face and a second inclined face are respectively formed at an upstream side and a downstream side of the measuring groove based on a rotation direction of the agitator.

5. The developing device of claim 2, further comprising a cleaning blade which is disposed on the rotation shaft of the agitator and which sweeps the developing agent in the measuring groove as the agitator is rotated.

6. The developing device of claim 2, further comprising a magnetic member which is disposed on the rotation shaft of the agitator and which removes the developing agent from the measuring groove due to a magnetic force as the agitator is rotated, wherein the magnetic member is a first cleaning member.

7. The developing device of claim 6, further comprising a second cleaning member which is disposed at the upstream side of the measuring groove based on the rotation direction of the agitator, which collides with the developing agent attached to the magnetic member, and which removes the developing agent from the magnetic member.

8. The developing device of claim 1, wherein the agitator comprises a rotation shaft and spiral agitating wings, which are disposed on the rotation shaft to convey the developing agent in the axial direction of the agitator, and wherein the pair of opposite electrodes are separated from each other in a direction that crosses the axial direction of the agitator.

9. The developing device of claim 8, wherein a first inclined face and a second inclined face are respectively formed at an upstream side and a downstream side of the measuring groove based on a rotation direction of the agitator.

10. The developing device of claim 8, wherein an inlet downwardly-inclined face and a discharge upwardly-inclined face are respectively formed at an upstream side and a downstream side of the measuring groove in a direction in which the developing agent is conveyed by the agitator.

11. The developing device of claim 8, further comprising a cleaning blade which is disposed on the rotation shaft of the agitator and which sweeps the developing agent in the measuring groove as the agitator is rotated.

12. The developing device of claim 8, further comprising a magnetic member which is disposed on the rotation shaft of the agitator and which removes the developing agent from the measuring groove due to a magnetic force as the agitator is rotated, wherein the magnetic member is a first cleaning member.

13. The developing device of claim 12, further comprising a second cleaning member which is disposed at the upstream side of the measuring groove based on the rotation direction of the agitator, which collides with the developing agent attached to the magnetic member, and which removes the developing agent from the magnetic member.

14. The developing device of claim 1, wherein the measuring groove is positioned in a vertical downward direction of the agitator.

15. The developing device of claim 14, wherein the agitator comprises a rotation shaft and spiral agitating wings which are disposed on the rotation shaft and which convey the developing agent in an axial direction of the agitator, and wherein a width of the measuring groove in a direction that crosses the axial direction of the agitator is less than a diameter of each of the agitating wings.

16. A developing device comprising:
an accommodation unit to accommodate a two-component developing agent comprising a toner and a carrier;
an agitator which is disposed in the accommodation unit and which conveys the developing agent in an axial direction of the agitator as the agitator is rotated; and
a toner concentration sensor which detects a concentration of the toner contained in the developing agent in the accommodation unit by using electrostatic capacity,
wherein the toner concentration sensor comprises:
a measuring groove formed in a vertical downward direction of the agitator to be concave with respect to an inner surface of a housing that forms the accommodation unit;
a pair of opposite electrodes disposed on the measuring groove to face each other in one of the axial direction of the agitator and a direction that crosses the axial direction; and
a first cleaning member which removes the developing agent from the measuring groove at least once when the agitator is rotated once.

17. The developing device of claim 16, wherein the first cleaning member comprises a magnetic member which is disposed on the rotation shaft of the agitator and which removes the developing agent from the measuring groove due to a magnetic force as the agitator is rotated.

18. The developing device of claim 17, further comprising a second cleaning member which is disposed at an upstream side of the measuring groove based on the rotation direction of the agitator, which collides with the developing agent attached to the magnetic member, and which removes the developing agent from the magnetic member.

19. The developing device of claim 18, wherein the pair of opposite electrodes face each other in the direction that crosses the axial direction of the agitator, and wherein an inlet downwardly-inclined face and a discharge upwardly-inclined face are respectively formed at the upstream side and a downstream side of the measuring groove in the axial direction of the agitator.

20. An image forming apparatus comprising the developing device of claim 16 and a photoconductor, wherein:
an electrostatic latent image is formed on the photoconductor; and
the developing device supplies the toner to the electrostatic latent image to develop the electrostatic latent image.

21. The image forming apparatus of claim 20, wherein the first cleaning member comprises a magnetic member which is disposed on the rotation shaft of the agitator and which removes the developing agent from the measuring groove due to a magnetic force as the agitator is rotated.

22. The image forming apparatus of claim 21, further comprising a second cleaning member which is disposed at an upstream side of the measuring groove based on the rotation direction of the agitator, which collides with the developing agent attached to the magnetic member, and which removes the developing agent from the magnetic member.

23. The image forming apparatus of claim 22, wherein the pair of opposite electrodes face each other in the direction that crosses the axial direction of the agitator, and wherein an inlet downwardly-inclined face and a discharge upwardly-inclined face are respectively formed at the upstream side and a downstream side of the measuring groove in the axial direction of the agitator.
